(19) United States
(12) Patent Application Publication
(10) Pub. No.: US 2007/0013682 A1
(43) Pub. Date: Jan. 18, 2007

(54) ELECTRONIC DEVICE WITH ROTARY KNOB

(75) Inventors: San-Feng Lin, Taipei (TW); Hui-Wen Chiu, Taipei (TW); Yen-Yu Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 11/428,572

(22) Filed: Jul. 5, 2006

(30) Foreign Application Priority Data
Jul. 12, 2005 (TW) 94123500

(51) Int. Cl. G09G 5/00

(52) U.S. Cl. 345/184

(57) ABSTRACT

An electronic device with a rotary knob includes a casing, a rotary knob and a switch. Wherein, the casing has an opening, the rotary knob is pivoted on the casing and locates in the opening. In addition, the rotary knob includes a first interconnecting part used for engaging with a second interconnecting part on the switch. As the rotary knob is turned by an external force, the first interconnecting part of the rotary knob would drive the second interconnecting part to move, so that the second interconnecting part shifts from a first position to a second position, which results in switching the switch and activating corresponding function.

### CROSS-REFERENCE TO RELATED APPLICATION

This application claims the priority benefit of Taiwan application serial no. 94123500, filed on Jul. 12, 2005. All disclosure of the Taiwan application is incorporated herein by reference.

### BACKGROUND OF THE INVENTION

1. Field of Invention

The present invention relates to an electronic device, and particularly to an electronic device with a rotary knob.

2. Description of the Related Art

Because of science and technology progresses, notebook computers are ubiquitous and have become an indispensable part to the modern life and work. The functionality, convenience and variety in the application of a notebook computer are directly related to a user's work, life and entertainment. Meanwhile, the notebook manufacturers have poured enormous amount of money on improvement and development of notebook computers, no matter on launching new functions or reducing production cost so as to increase competitiveness.

FIG. 1 is a schematic 3-dimensional drawing of a conventional notebook computer. Referring to FIG. 1, a conventional notebook computer 100 includes a main body 110 and a display 120. Wherein, the main body 110 mainly includes a pivot portion 112, a plurality of keys 114 and a plurality of function keys 116. The pivot portion 112 is connected to the display 120 and enables the display 120 to swing up and down in relation to the main body 110. The keys 114 are disposed on an upper chassis 110a, while the function keys 116 are also disposed on the upper chassis 110a and locate on the periphery of the keys 114. A user inputs information into the main body 110 with the keys 114. Besides, a user can also press the function keys 116 to activate the functions corresponding to the pressed function keys, for example, to activate a power-save mode.

Generally speaking, a compression spring is disposed under a function key 116 (not shown). When a function key 116 on the main body 110 is pressed down for activating a function, a switch (not shown) alters the status thereof and activates the corresponded function. Contrarily, when the pressed function key is released, the compression spring restores the function key 116 back to its initial position.

However, the available space inside the upper chassis 110a of the notebook computer 100 is very limited. If the function keys 116 are disposed on the periphery of the keys 114, the upper chassis 110a may appear complex. Although such conventional design of the function keys 116 is simpler, it is not practical because the function keys, such as power on/off or power-save mode, are not frequently used. On the other hand, the above-described conventional design of the function keys 116 would remarkably reduce the quality sense of the notebook computer 100, even give users a monotonous feeling.

### SUMMARY OF THE INVENTION

An object of the present invention is to provide an electronic device with a rotary knob, wherein a rotary knob is disposed on the electronic device, so that a user can activate the desired functions by turning the knob with a better sense and moreover, the quality sense of the electronic device is advanced.

Based on the above-mentioned object or the others, the present invention provides an electronic device with a rotary knob, which includes a casing, a rotary knob and a switch. Wherein, the casing has an opening and the rotary knob is pivoted on the casing. Besides, the rotary knob is disposed in the opening and has a first interconnecting part used for engaging with a second interconnecting part disposed on the switch. When the rotary knob is turned by an external force, the first interconnecting part would drive the second interconnecting part on the switch to shift the second interconnecting part from a first position to a second position, so that the switch is switched for activating a corresponding function.

In a preferred embodiment of the present invention, the rotary knob may have a circular profile and has at least a concave/convex contour on the rim surface thereof for a user to comfortably turn around the rotary knob.

In a preferred embodiment of the present invention, the electronic device can, for example, include a display and a main body. The display is pivoted on a pivot portion of the main body while the opening is made at the pivot portion.

In a preferred embodiment of the present invention, the electronic device further includes a circuit board. Wherein, the circuit board is disposed in the casing and the switch is disposed on the circuit board. As the switch is switched, the corresponding function is activated by the circuit board.

In a preferred embodiment of the present invention, the electronic device further includes a first restoration component, which is disposed on a pivot axle of the rotary knob. Wherein, an end of the first restoration component is held up on the rotary knob, while another end thereof is held up on the casing. When the external force is removed, the rotary knob would be restored back to the first position by the first restoration component. The first restoration component can be a torsion spring.

In a preferred embodiment of the present invention, the first interconnecting part can be, for example, a notch, and the second interconnecting part can be, for example, a lever engaged in the notch.

In a preferred embodiment of the present invention, the switch further includes a second restoration component. After the second interconnecting part moves from the first position to the second position, the second interconnecting part can be restored back to the first position by the second restoration component. The second restoration component can be a compression spring.

In the electronic device with a rotary knob disclosed by the present invention, the rotary knob design is cloned in the pivot portion of a notebook computer, so that users can activate the desired functions by turning the rotary knob with a good quality sense. In addition, the function keys in a conventional notebook computer are disposed on the pivot axle according to the present invention, which makes the upper chassis of a notebook computer appear neatly.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic 3-dimensional drawing of a conventional notebook computer.

FIG. 2 is a schematic 3-dimensional drawing of a notebook computer with a rotary knob of the present invention.

FIG. 3 is a schematic localized 3-dimensional drawing of the notebook computer with a rotary knob of the present invention.

FIG. 4 is a schematic localized 3-dimensional drawing showing the inside structure of the pivot portion in a notebook PC.

FIG. 5A and FIG. 5B are schematic localized 3-dimensional drawings of the rotary knob from two different viewing directions, respectively.

FIG. 6 is a schematic localized 3-dimensional drawing showing the pivot portion with a rotary knob of the present invention.

FIG. 7A and FIG. 7B are schematic localized 3-dimensional drawings showing activations of the rotary knob of the present invention.

FIG. 8A and FIG. 8B are diagrams showing the second interconnecting part on the switch of the present invention at the first position and the second position, respectively.

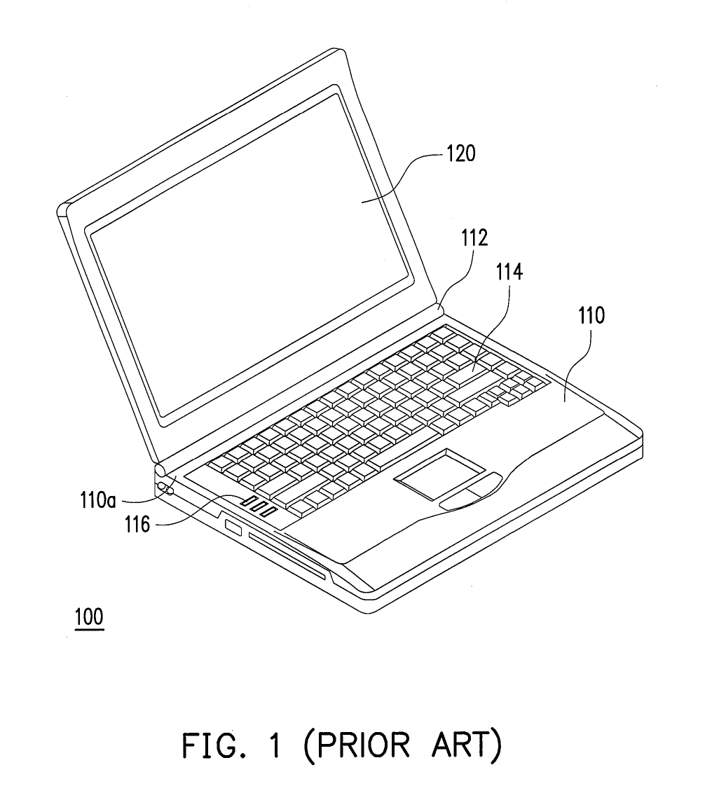

### DESCRIPTION OF THE EMBODIMENTS

A notebook computer is exemplary, but not limited to, for explaining the electronic device with a rotary knob in the present invention hereafter. In fact, the present invention is also applicable to other electronic devices with a casing.

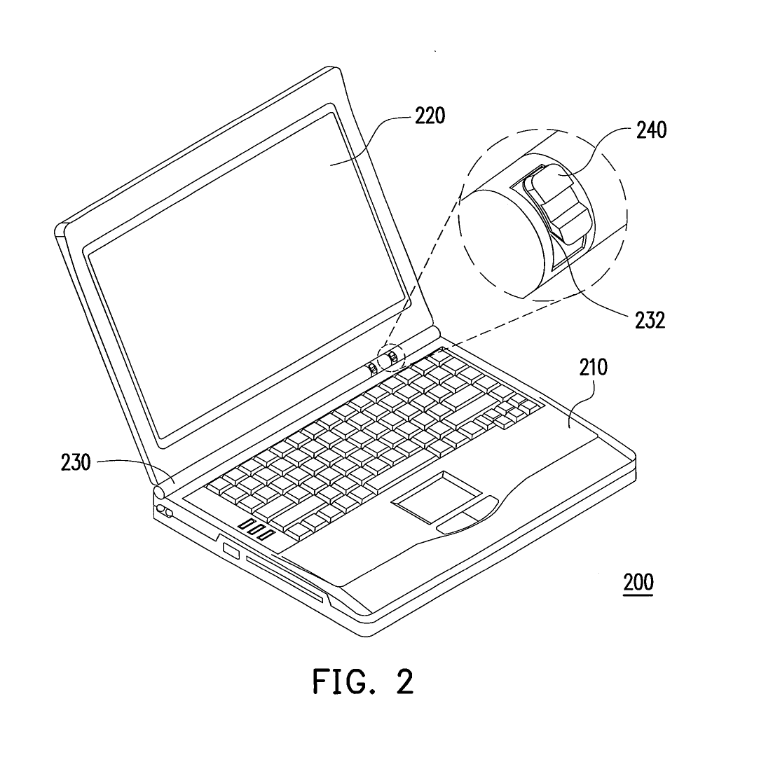

FIG. 2 is a schematic 3-dimensional drawing of a notebook computer with a rotary knob of the present invention. Referring to FIG. 2, a notebook computer 200 with a rotary knob includes a main body 210, a display 220, a pivot portion 230 and a rotary knob 240. Wherein, the display 220 is pivoted on the pivot portion 230 to enable the display 220 being turned up and down in relation to the main body 210. The appearance of the pivot portion 230 can be an arc form and with an opening 232. The rotary knob 240 is disposed in the pivot portion 230 of the main body 210 and is exposed out of the opening 232. Users can turn the rotary knob 240 to activate the desired function, such as power-save mode. In this way, the user will feel a good quality sense while using the computer. Besides, since the rotary knob 240 is disposed in the pivot portion 230 of the main body 210 in the present invention, the available space inside the upper chassis of the main body is increased.

In the following, the components included in the notebook computer with a rotary knob of the present invention and the interactions between the components are described in detail.

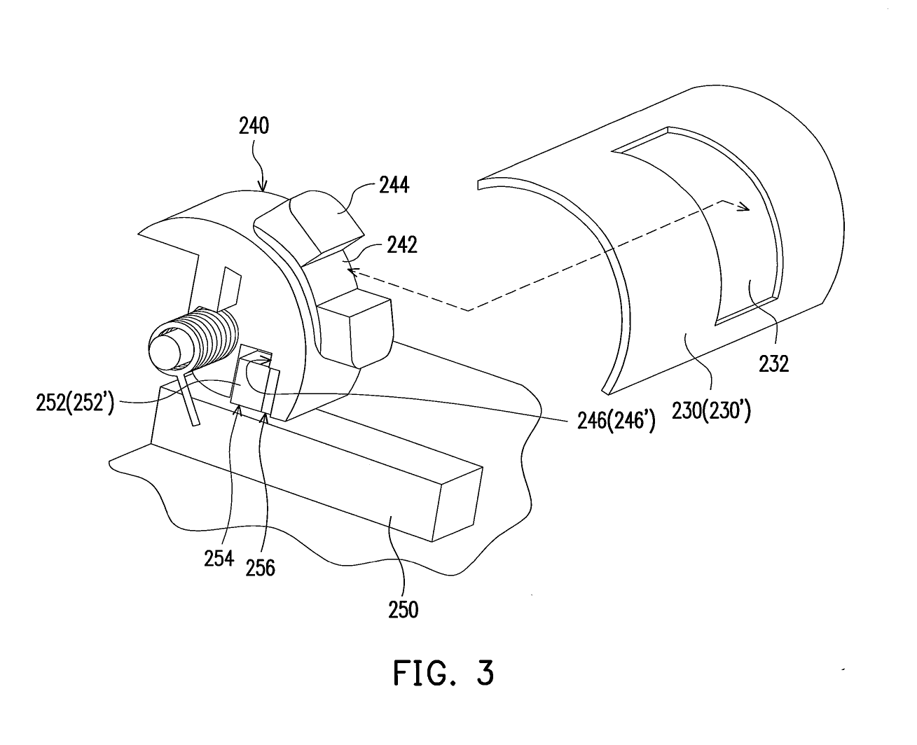

FIG. 3 is a schematic localized 3-dimensional drawing of the notebook computer with a rotary knob of the present invention. Referring to FIG. 2 and FIG. 3, the notebook computer 200 with a rotary knob includes a pivot portion 230, a rotary knob 240 and a switch 250. Wherein, the pivot portion 230 in the arc form and with an opening 232 is one part of the casing 230′. The rotary knob 240 is pivoted on the casing 230′ and includes a first element 242, a second element 244 and a first interconnecting part 246. The first element 242 of the rotary knob 240 is disposed inside the opening 232 of the pivot portion 230, while the second element 244 thereof is protruded from the pivot portion 230, such that a user can conveniently turn the rotary knob 240. The first interconnecting part 246 is used for driving the switch 250. The first interconnecting part 246 is a notch 246′ in the present embodiment. The switch 250 has a second interconnecting part 252, which engages with the first interconnecting part 246 of the rotary knob 240. In addition, the second interconnecting part 252 occupies a first position 254 and a second position 256. As the rotary knob 240 turns by an external force, the first interconnecting part 246 of the rotary knob 240 would drive the second interconnecting part 252 of the switch 250, so that the second interconnecting part 252 moves from the first position 254 to the second position 256 resulting in switching the switch 250. In the embodiment, the second interconnecting part 252 can be a lever 252′, and the shape and the dimensions of the lever 252′ must be designed to adapt the shape and the dimensions of the notch 246′.

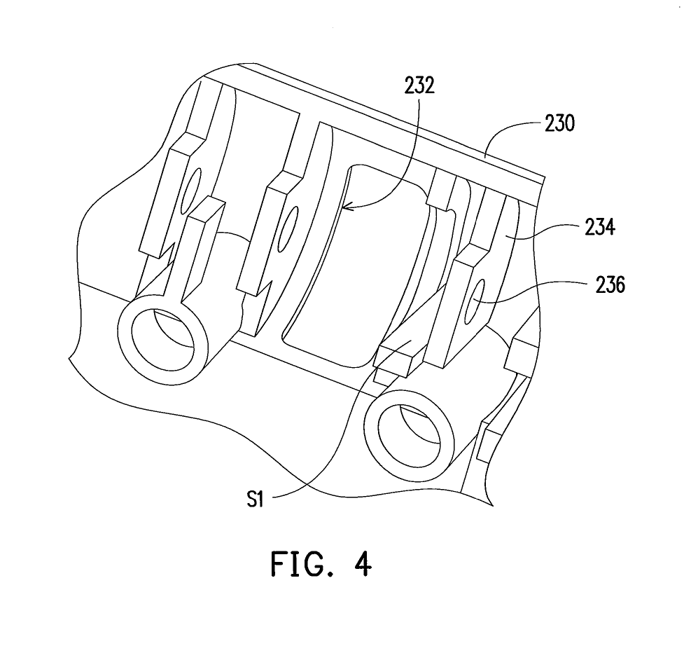

FIG. 4 is a schematic localized 3-dimensional drawing showing the inside structure of the pivot portion in a notebook computer. Referring to FIG. 4, the pivot portion 230 has an opening 232. Two bearing housings 234 are disposed at both sides of the opening 232 inside the pivot portion 230, respectively. Each bearing housing 234 has a pivoting hole 236 to support the rotary knob 240. In addition, there is a first supporting face S1 disposed on the pivot portion 230 near to one of the bearing housings 234.

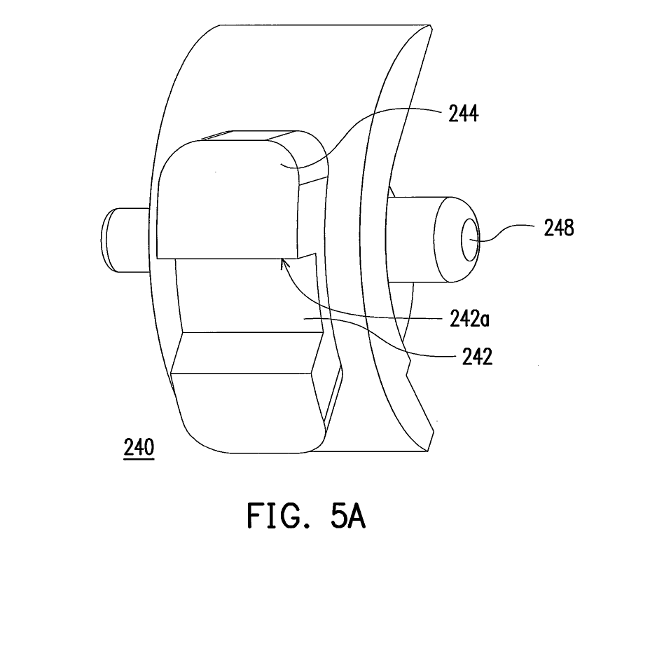

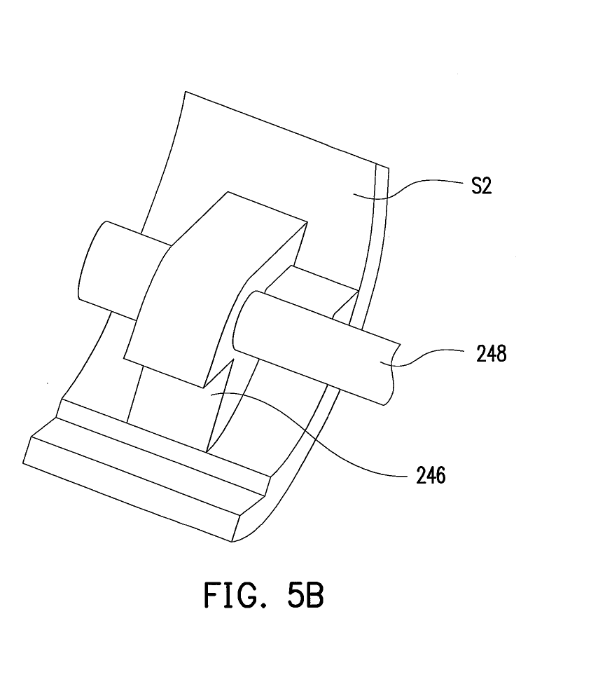

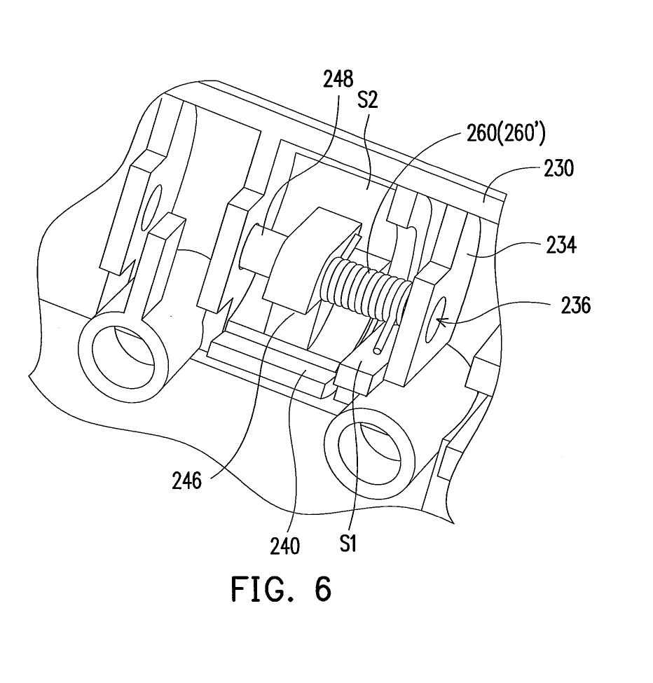

FIG. 5A and FIG. 5B are schematic localized 3-dimensional drawings of the rotary knob from two different viewing directions, respectively. Referring to FIG. 5A, FIG. 5B, and FIG. 6, except for the above-described first element 242, second element 244 and first interconnecting part 246, the rotary knob 240 further includes a notch 242a, a pivot axle 248 and a second supporting face S2. The notch 242a is disposed at the first element 242 of the rotary knob 240 so that a user can conveniently turn the rotary knob 240. In addition, the rotary knob 240 is pivoted on the bearing housings 234 of the pivot portion 230 through the pivot axle 248, and the rotary knob 240 can be a circular-like shape to adapt the shape of the pivot portion 230.

FIG. 6 is a schematic localized 3-dimensional drawing showing the pivot portion with a rotary knob of the present invention. Referring to FIG. 5A and 6, the pivot axle 248 of the rotary knob 240 is passed through the two pivoting holes 236 and pivoted on them. A second element 244 of the rotary knob 240 is protruded from the pivot portion 230 and able to turn in relation to the pivot portion 230. In addition, a first restoration component 260 is further disposed on the pivot axle 248 of the rotary knob 240. One end of the first restoration component 260 is held up on the first supporting face S1 of the pivot portion 230, while another end thereof is held up on the second supporting face S2 of the rotary knob 240. After the rotary knob 240 departs from the initial position under an external force, the first restoration component 260 enables the rotary knob 240 to restore back to the initial position once the external force is removed. In the embodiment, the first restoration component 260 can be, but not limited to, a torsion spring 260′.

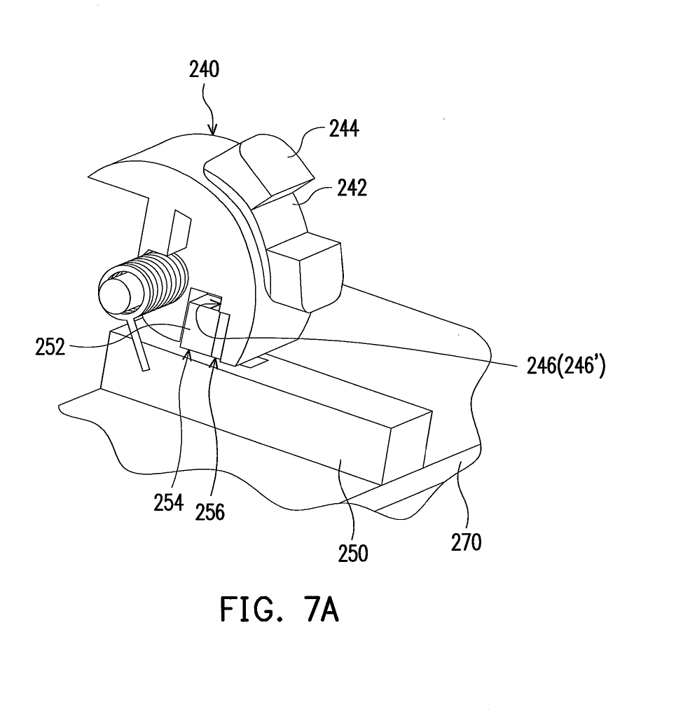

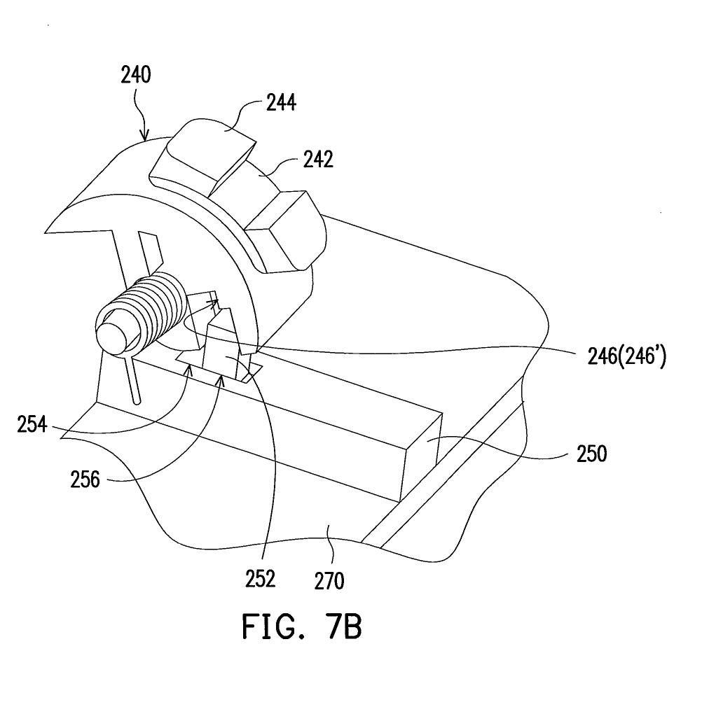

FIG. 7A and FIG. 7B are schematic localized 3-dimensional drawings showing activations of the rotary knob of the present invention. Referring to FIG. 7A, the first interconnecting part 246 of the rotary knob 240 and the second interconnecting part 252 of the switch 250 are engaged with each other. Referring to FIG. 7B, as the rotary knob 240 is turned by a user, the first interconnecting part 246 of the rotary knob 240 would drive the second interconnecting part 252 of the switch 250, so that the second interconnecting part 252 shifts from the first position 254 to the second position 256. Thus, the switch 250 is switched and the corresponding function is activated. Furthermore, the notebook computer 200 (as shown in FIG. 2) further includes a circuit board 270, and the switch 250 locates on the circuit board 270. As the second interconnecting part 252 shifts from the first position 254 to the second position 256 for switching the switch 250, the switch 250 would activate the corresponding function through the circuit board 270.

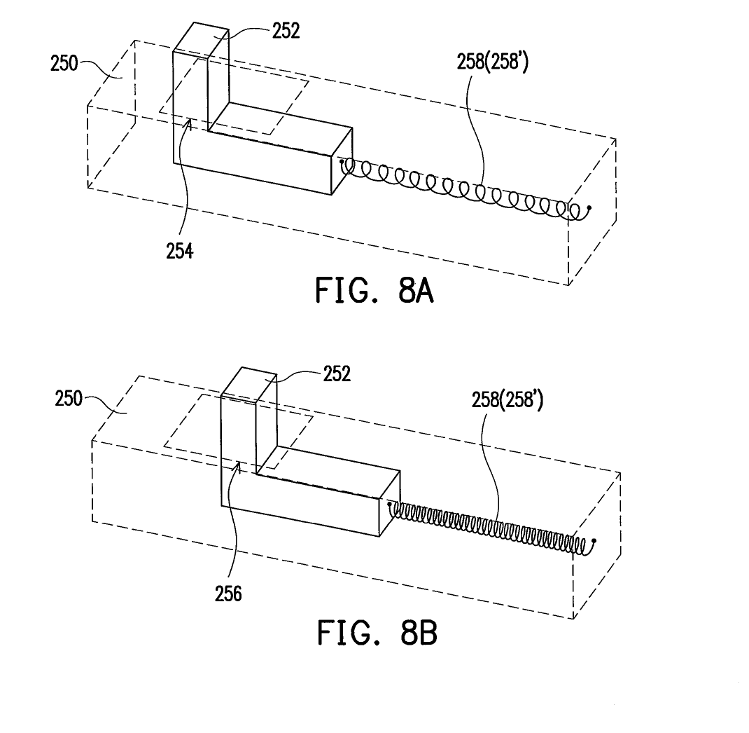

FIG. 8A and FIG. 8B are diagrams showing the second interconnecting part on the switch of the present invention at the first position and the second position, respectively. Referring to FIGS. 8A and 8B, inside the switch 250 there is further a second restoration component 258. As the second interconnecting part 252 of the switch 250 shifts from the first position 254 to the second position 256, the second restoration component 258 is compressed and deformed. Therefore, once the external force is removed, the accumulated elastic potential energy within the second restoration component 258 enables the second interconnecting part 252 to restore back from the second position 256 to the first position 254. In the embodiment, the second restoration component 258 can be, but not limited to, a compression spring.

In the above-described embodiment, both a first restoration component and a second restoration component are disposed on the rotary knob and the switch, respectively, to ensure precise restoration activations of the rotary knob and the switch. In fact, practically, only one restoration component is needed to achieve the same result that reduces the cost. Besides, different from the conventional electronic devices which no key-press switches are disposed at the pivot portion, a circular-like space at the pivot portion is used for disposing a rotary knob as a switch in the present invention. Accordingly, the present invention does not only create a novel outlook but also increases utilization of the overall space.

From the above described, since a rotary knob is disposed to link the switch in an electronic device of the present invention, a user can turn the rotary knob to activate the corresponding function and obtain a better quality sense. In addition, the rotary knob can further be disposed on the pivot portion of the electronic device to increase utilization of the overall space.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. An electronic device with a rotary knob, comprising:
a casing, having an opening disposed on the casing;
a rotary knob, pivoted on the casing, wherein the rotary knob is disposed in the opening and comprises a first interconnecting part; and
a switch, a second interconnecting part disposed on the switch and engaging with the first interconnecting part;
wherein, as the rotary knob is turned by an external force, the first interconnecting part drives the second interconnecting part and enables the second interconnecting part to shift from a first position to a second position.

2. The electronic device with a rotary knob as recited in claim 1, wherein the rotary knob has a circular-like shape.

3. The electronic device with a rotary knob as recited in claim 1, further comprising a display and a main body, wherein the display is pivoted on a pivot portion of the main body and the pivot portion is adjacent to the opening.

4. The electronic device with a rotary knob as recited in claim 1, further comprising a circuit board mechanically connected to the casing, wherein the switch is disposed on the circuit board.

5. The electronic device with a rotary knob as recited in claim 1, further comprising a first restoration component disposed on a pivot axle of the rotary knob, wherein an end of the first restoration component is held up on the rotary knob and another end thereof is held up on the casing.

6. The electronic device with a rotary knob as recited in claim 5, wherein the first restoration component is a torsion spring.

7. The electronic device with a rotary knob as recited in claim 1, wherein the first interconnecting part is a notch of the rotary knob, the second interconnecting part is a lever, and the second interconnecting part is engaged in the first interconnecting part.

8. The electronic device with a rotary knob as recited in claim 1, wherein the switch further comprises a second restoration component; after the second interconnecting part shifts from the first position to the second position, the second interconnecting part is able to return back from the second position to the first position by the second restoration component.

9. The electronic device with a rotary knob as recited in claim 8, wherein the second restoration component is a compression spring.
